(19) United States
(12) Patent Application Publication
(10) Pub. No.: US 2023/0085047 A1
(43) Pub. Date: Mar. 16, 2023

(54) EXCREMENT TREATMENT MATERIAL AND METHOD FOR MANUFACTURING THE SAME

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 17/992,506

(22) Filed: Nov. 22, 2022

Related U.S. Application Data
(63) Continuation of application No. PCT/JP2021/028596, filed on Aug. 2, 2021.

(30) Foreign Application Priority Data
Aug. 26, 2020 (JP) 2020-142259

(51) Int. Cl. A01K 1/015

(52) U.S. Cl. CPC A01K 1/0155

(57) ABSTRACT

An excrement treatment material is composed of a large number of grains for treatment of excrement. The excrement treatment material includes a grain group. The grain group is composed of a plurality of grains before use that are mutually bonded, the plurality of grains being included in the large number of grains.

### CROSS REFERENCE TO RELATED APPLICATION

This is a Continuation of International Application No. PCT/JP2021/028596 filed Aug. 2, 2021, which claims the benefit of Japanese Application No. 2020-142259 filed Aug. 26, 2020. The contents of these applications are hereby incorporated by reference in their entirety.

### TECHNICAL FIELD

The present invention relates to an excrement treatment material and a method for manufacturing the same.

### BACKGROUND ART

A conventional excrement treatment material is disclosed, for example, in Patent Document 1. The excrement treatment material disclosed in Patent Document 1 is an excrement treatment material for animals, and composed of a large number of grains having a water absorbing property. This excrement treatment material is used in a state in which the large number of grains are laid in a box-shaped toilet.

### CITATION LIST

### Patent Document

Patent Document 1: JP 2007-190026 A

### SUMMARY OF INVENTION

### Technical Problem

In the toilet described above, an animal such as a cat excretes in a state of directly getting on the excrement treatment material. Therefore, there has been a problem that the grains scatter around the toilet after excretion due to the grains being caught in or adhering to a foot of the animal during excretion.

### Solution to Problem

The present invention has been made in view of the above-described problem, and it is an object thereof to provide an excrement treatment material that is unlikely to scatter around a toilet, and a method for manufacturing the same.

An excrement treatment material according to the present invention is composed of a large number of grains for treatment of excrement. The excrement treatment material includes a grain group that is composed of a plurality of grains before use that are mutually bonded, the plurality of grains being included in the large number of grains.

In this excrement treatment material, the grain group that is composed of the plurality of grains before use that are mutually bonded is provided. Naturally, the particle diameter and mass of the grain group are larger than those of each grain that composes the grain group. For this reason, it is possible to make the plurality of grains less likely to be caught in or adhere to a foot of an animal than in a case where the grains are mutually separated.

A method for manufacturing an excrement treatment material according to the present invention is a method for manufacturing an excrement treatment material that is composed of a large number of grains for treatment of excrement. The method includes: an each grain forming step of forming the large number of grains; and a grain group forming step of forming a grain group that is composed of a plurality of grains before use that are mutually bonded, the plurality of grains being included in the large number of grains formed in the each grain forming step.

In this manufacturing method, the grain group that is composed of the plurality of grains before use that are mutually bonded is formed. Naturally, the particle diameter and mass of the grain group are larger than those of each grain that composes the grain group. For this reason, in the manufactured excrement treatment material, it is possible to make the plurality of grains less likely to be caught in or adhere to a foot of an animal than in a case where the grains are mutually separated.

### Advantageous Effects of Invention

According to the present invention, it is possible to implement an excrement treatment material that is unlikely to scatter around a toilet, and a method for manufacturing the same.

### BRIEF DESCRIPTION OF DRAWINGS

FIG. 1 is a schematic view showing an embodiment of an excrement treatment material according to the present invention.

FIG. 2 is a schematic view showing a grain 10.

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

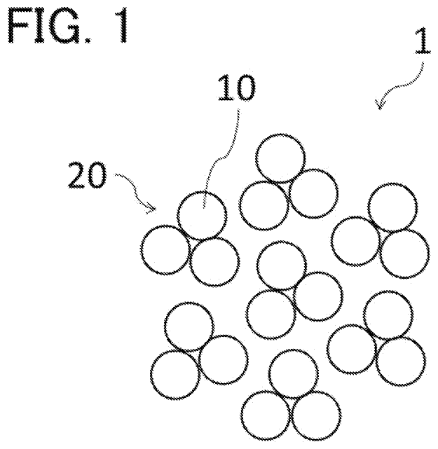

FIG. 1 is a schematic view showing an embodiment of an excrement treatment material according to the present invention. An excrement treatment material 1 is an excrement treatment material used for treatment of excrement (particularly urine), and composed of a large number of grains 10 for treatment of excrement. As used herein, “large number” means that the number of grains 10 is 10 or more. The excrement treatment material 1 may be an excrement treatment material for animals that treats excrement of animals such as cats or dogs, or may be an excrement treatment material for humans that treats excrement of humans. The excrement treatment material 1 is used, for example, in a state in which the large number of grains 10 are laid in a box-shaped toilet.

In the present embodiment, the grains 10 are water absorption type grains that treat excrement by absorbing the excrement. The particle diameter of each grain 10 is, for example, between 5 mm and 15 mm inclusive. As used herein, the particle diameter of the grain 10 shall be defined as the diameter of the minimum sphere that can include the grain 10.

Each grain 10 contains an organic substance as its main material. As used herein, the main material of the grain 10 refers to the material that accounts for the highest weight ratio in the grain 10, out of one or more materials constituting the grain 10. As the organic substance, for example, papers, used tea leaves, plastics, or bean curd lees can be used. Each grain 10 may be made only of an organic substance, or may be made of an organic substance and an inorganic substance.

The papers refer to a material made mainly of pulp. Examples of the papers include, in addition to ordinary paper, a vinyl chloride wallpaper classified product (paper obtained by classifying vinyl chloride wallpaper), fluff pulp, papermaking sludge, and pulp sludge. As the plastics, for example, a disposable diaper classified product (plastic obtained by classifying disposable diapers) may be used. The bean curd lees are preferably dried bean curd lees.

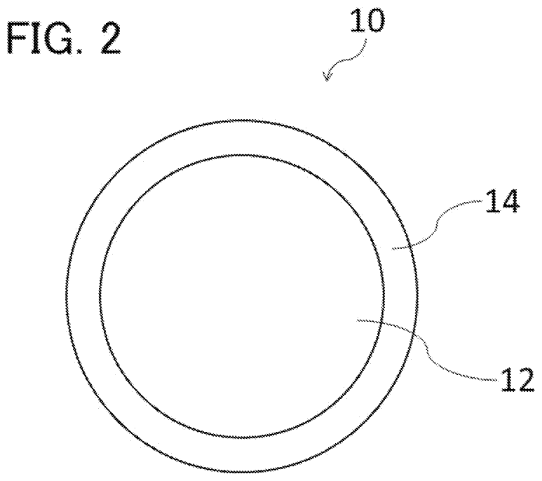

FIG. 2 is a schematic view showing the grain 10. Each grain 10 includes a core portion 12 and a coating portion 14. The core portion 12 is a granule formed in a granular shape. Examples of the granular shape include a column, sphere, and ellipsoid. The core portion 12 has a function of absorbing and retaining excrement. The core portion 12 contains an organic substance as its main material. The core portion 12 may or may not contain an adhesive material. As the adhesive material, for example, CMC (carboxymethyl cellulose), PVA (polyvinyl alcohol), dextrin, or a water-absorbent polymer can be used. Each grain 10 includes only one core portion 12 (granule).

The coating portion 14 covers the core portion 12. The coating portion 14 may cover the entire surface of the core portion 12, or may cover only a part of the surface of the core portion 12. The coating portion 14 has a function of bonding the grains 10 (detailedly grain groups 20 described later) that have absorbed excrement to agglomerate them when in use. The coating portion 14 contains an adhesive material. The coating portion 14 also contains an organic substance as its main material.

Returning to FIG. 1, the excrement treatment material 1 includes a grain group 20. The grain group 20 is composed of a plurality of the grains 10 that are included in the large number of grains 10 described above (all of the grains 10 that compose the excrement treatment material 1).

Specifically, the grain group 20 is composed of the plurality of grains 10 before use that are mutually bonded. The grain group 20 is preferably composed of n grains 10 (n represents an integer between 2 and 5) that are mutually bonded. Also, the particle diameter of the grain group 20 is preferably 1.5 times or more and 3 times or less of the particle diameter of each of the grains 10 composing the grain group 20. As used herein, the particle diameter of the grain group 20 shall be defined as the diameter of the minimum sphere that can include the grain group 20.

The excrement treatment material 1 includes a plurality of the grain groups 20. The numbers of the grains 10 composing the respective grain groups 20 may be equal to one another, or may be different from one another. In the latter case, it follows that the plurality of grain groups 20 include a first grain group that is composed of p grains 10 (p represents an integer of 2 or more) that are mutually bonded, and a second grain group that is composed of q grains 10 (q represents an integer of 2 or more, and is different from p) that are mutually bonded. Note that all of “the large number of grains 10” may compose the grain groups 20, or only a part of “the large number of grains 10” may compose the grain groups 20. In the latter case, the remaining grains 10 are present independently without being bonded to other grains 10. In the excrement treatment material 1, all or a part of the grains 10 composing the excrement treatment material 1 are bonded to other grain(s) 10 before use (before receiving excrement) to compose the grain groups 20 in this way.

Next, an example of a method for manufacturing the excrement treatment material 1 will be described as an embodiment of a method for manufacturing an excrement treatment material according to the present invention. This manufacturing method includes an each grain forming step, and a grain group forming step.

The each grain forming step is a step of forming the large number of grains 10. The each grain forming step includes a granulating step, and a coating step. The granulating step is a step of forming the core portion 12 that constitutes each of the large number of grains 10. In the granulating step, a large number of the core portions 12 are formed by granulating a granulating material (the material(s) constituting the core portion 12) with a granulation apparatus. As the granulation apparatus, for example, an extrusion granulator can be used. Prior to the granulation, pretreatment such as pulverization, kneading, and adding water is performed on the granulating material as needed.

The coating step is a step of forming the coating portion 14 so as to cover each core portion 12. In this step, the coating portion 14 is formed by attaching a powdery coating material (materials constituting the coating portion 14) to the surface of each core portion 12 with a coating apparatus or the like. The coating material may be attached, for example, by sprinkling or spraying. After that, posttreatment such as sieving (sizing), and drying is performed as needed. Accordingly, the large number of grains 10 are obtained.

The grain group forming step is a step of forming the grain group 20. In this step, the grain group 20 is formed by bonding the plurality of grains 10 mutually that have been formed in the each grain forming step. For example, an adhesive material can be used for bonding the grains 10. As the adhesive material for bonding the grains 10, the adhesive material that is contained in each grain 10 may be used, or an adhesive material that is prepared separately (an adhesive material that is not contained in each grain 10) may be used. In the former case, for example, the plurality of grains 10 can be mutually bonded by pressing the grains 10 against each other in a state in which the surface of each grain 10 is moderately wet, for example, by adding water to the surface. In the present embodiment, the plurality of grain groups 20 are formed. Accordingly, the excrement treatment material 1 including the grain groups 20 is obtained.

The effects of the present embodiment will be described. In the present embodiment, the grain group 20 that is composed of the plurality of grains 10 before use that are mutually bonded is formed. Naturally, the particle diameter and mass of the grain group 20 are larger than those of each grain 10 that composes the grain group 20. For this reason, in the excrement treatment material 1, it is possible to make the plurality of grains 10 less likely to be caught in or adhere to a foot of an animal than in a case where the grains 10 are mutually separated. Accordingly, the excrement treatment material 1 that is unlikely to scatter around a toilet, and the method for manufacturing the same are implemented.

Incidentally, as a means of obtaining grains that are unlikely to be caught in or adhere to a foot of an animal, it can also be considered to form grains having a large particle diameter from the first. However, if it is tried to make the particle diameter of each grain large, an adverse effect such as making granules likely to collapse during manufacturing may occur. In this regard, according to the present embodiment, it is possible to obtain the grain group 20 having a large particle diameter without making the particle diameter of each grain 10 large.

The larger the grain group 20 is, the less likely the grains 10 become to be caught in or adhere to a foot of an animal. On the other hand, if the grain group 20 is too large, it may cause such hindrance in handling the excrement treatment material 1 that the surface of the excrement treatment material 1 laid in a toilet (aggregate of the large number of grains 10) is difficult to level. From this viewpoint, the number (n) of the grains 10 composing the grain group 20 is preferably between 2 and 5 inclusive. From the same viewpoint, the particle diameter of the grain group 20 is preferably 1.5 times or more and 3 times or less of the particle diameter of each of the grains 10 composing the grain group 20.

In the case where each grain 10 is in a columnar shape, the granules (core portions 12) constituting the grains 10 can be formed by extrusion granulation. This is advantageous for forming the large number of grains 10 in a short time.

Each grain 10 includes the core portion 12 that is a granule. Because it is easy to form various materials into a granular shape by the method of granulation, a range of selection of materials used for the grains 10 can be expanded.

Each grain 10 includes the coating portion 14 that contains the adhesive material. Thus, it is possible to obtain an agglomeration of a plurality of the grain groups 20 after use.

In the case where the core portion 12 does not contain an adhesive material, it is possible to save the amount of adhesive material used, and reduce the manufacturing cost of the excrement treatment material 1.

In the case where each grain 10 contains an organic substance as its main material, it is possible to obtain the grains 10 suitable for being disposed of by incineration. In this case, the excrement treatment material 1 after use can be easily disposed of as burnable garbage, which therefore increases convenience for users. In the case where each grain 10 is made only of the organic substance, it is possible to obtain the grains 10 particularly suitable for being disposed of by incineration.

The excrement treatment material 1 is provided with the plurality of grain groups 20. Thus, the excrement treatment material 1 having high practicality can be obtained, compared to a case where only one grain group 20 is provided.

In the case where the numbers of the grains 10 composing the respective grain groups 20 are different from one another, the grain groups 20 having various particle diameters are mixed in the excrement treatment material 1. In this case, when the excrement treatment material 1 is laid in a toilet, the grain groups 20 having relatively small particle diameters are likely to enter gaps between the grain groups 20 having relatively large particle diameters. For this reason, it is possible to lay the plurality of grain groups 20 in the toilet at high density.

The present invention is not limited to the above-described embodiment, and various modifications can be made. In the above-described embodiment, an example is given in which each grain 10 has multi-layer structure (double-layer structure) composed of the core portion 12 and the coating portion 14. However, it is not essential to provide the coating portion 14. That is, each grain 10 may have single-layer structure composed only of the core portion 12. In that case, it is preferable that the core portion 12 contains an adhesive material. In the case where each grain 10 includes only the core portion 12 in this way, excrement can reach the core portion 12 immediately due to the core portion 12 being uncovered. This is advantageous for enhancing water absorption velocity of the grain 10.

In the above-described embodiment, an example is given in which each grain 10 contains an organic substance as its main material. However, each grain 10 may contain an inorganic substance as its main material.

In the above-described embodiment, an example is given in which the grains 10 are water absorption type and treat excrement by absorbing the excrement. However, the grains 10 may be water permeable type grains that treat excrement by allowing the excrement to pass therethrough. Here, there are two kinds of the water permeable type grains, one in which the excrement passes through the interior of the grains, and the other in which the excrement passes through a gap between the grains. Examples of the latter grains include grains having water repellency.

### LIST OF REFERENCE NUMERALS

1 Excrement Treatment Material
10 Grain
12 Core Portion (Granule)
14 Coating Portion
20 Grain Group

1. An excrement treatment material that is composed of a large number of grains for treatment of excrement, the excrement treatment material comprising:
a grain group that is composed of a plurality of grains before use that are mutually bonded, the plurality of grains being included in the large number of grains.

2. The excrement treatment material according to claim 1,
wherein the grain group is composed of n said grains that are mutually bonded, and
the n represents an integer between 2 and 5.

3. The excrement treatment material according to claim 1,
wherein a particle diameter of the grain group is 1.5 times or more and 3 times or less of each of the grains composing the grain group.

4. The excrement treatment material according to claim 1,
wherein each of the grains is in a columnar shape.

5. The excrement treatment material according to claim 1,
wherein each of the grains includes a granule.

6. The excrement treatment material according to claim 5,
wherein each of the grains includes a coating portion that contains an adhesive material, and covers the granule.

7. The excrement treatment material according to claim 6,
wherein the granule does not contain an adhesive material.

8. The excrement treatment material according to claim 5,
wherein each of the grains is composed only of the granule.

9. The excrement treatment material according to claim 1,
wherein each of the grains contains an organic substance as a main material.

10. The excrement treatment material according to claim 9,
wherein each of the grains is made only of the organic substance.

11. The excrement treatment material according to claim 1, comprising:
a plurality of the grain groups.

12. The excrement treatment material according to claim 11,
wherein the plurality of grain groups include a first grain group that is composed of p said grains that are mutually bonded, and a second grain group that is composed of q said grains that are mutually bonded, and
the p and the q represent integers of 2 or more, and are different from each other.

13. A method for manufacturing an excrement treatment material that is composed of a large number of grains for treatment of excrement, the method comprising:
an each grain forming step of forming the large number of grains; and
a grain group forming step of forming a grain group that is composed of a plurality of grains before use that are mutually bonded, the plurality of grains being included in the large number of grains formed in the each grain forming step.

14. The method for manufacturing an excrement treatment material according to claim 13,
wherein in the each grain forming step, the large number of grains in a columnar shape are formed.

15. The method for manufacturing an excrement treatment material according to claim 13,
wherein the each grain forming step includes a granulating step of forming a granule that constitutes each of the large number of grains.

16. The method for manufacturing an excrement treatment material according to claim 15,
wherein the each grain forming step includes a coating step of forming a coating portion that contains an adhesive material, and covers the granule.

17. The method for manufacturing an excrement treatment material according to claim 16,
wherein in the granulating step, the granule that does not contain an adhesive material is formed.

18. The method for manufacturing an excrement treatment material according to claim 15,
wherein in the each grain forming step, the large number of grains that are each composed only of the granule are formed.

19. The method for manufacturing an excrement treatment material according to claim 13,
wherein in the each grain forming step, the large number of grains that each contain an organic substance as a main material are formed.

20. The method for manufacturing an excrement treatment material according to claim 19,
wherein in the each grain forming step, the large number of grains that are each made only of the organic substance are formed.
